(19) United States
(12) Patent Application Publication
(10) Pub. No.: US 2010/0281353 A1
(43) Pub. Date: Nov. 4, 2010

(54) Automated Annotating Hyperlinker

(76) Inventor: Joshua Neil Rubin, Brooklyn, NY (US)

Correspondence Address: NOVAK DRUCE + QUIGG LLP, 300 NEW JERSEY AVENUE, NW, FIFTH FLOOR, WASHINGTON, DC, 20001, US

(21) Appl. No.: 12/773,508

(22) Filed: May 4, 2010

Related U.S. Application Data
(60) Provisional application No. 61/175,348, filed on May 4, 2009.

(51) Int. Cl. G06F 17/00

(52) U.S. Cl. 715/208; 715/205; 715/230

(57) ABSTRACT

Creating a document assembly. In a central linking document stored in a computer data container, accepting input identifying at least one selected data. Retrieving metadata regarding at least one identified selected data. Creating at least one hyperlink anchor in the central linking document to at least one identified selected data using its corresponding retrieved metadata. Copying at least one hyperlinked selected data to the path of the computer data container storing the central linking document.

### CROSS REFERENCE TO RELATED DOCUMENTS

The present application claims the priority benefit of U.S. Provisional Patent Application No. 61/175,348, entitled “Automated Annotating Hyperlinker,” filed on May 4, 2009—the disclosure of which is hereby incorporated herein by reference in its entirety.

### FIELD

The technology disclosed herein (the “technology”) relates to document assembly. Exemplary embodiments of the technology relate to document assembly using hyperlinks and annotations thereto in a litigation support environment.

### SUMMARY

The technology includes systems, computer-implemented methods, and computer program products for creating a document assembly. In a central linking document stored in a computer data container, the technology can accept input identifying selected data. Metadata regarding the selected data can be retrieved, e.g., from a computer data container storing the selected data. Such a computer data container can be a litigation database. The technology can create hyperlink anchors in the central linking document. The hyperlink anchors are directed to the selected data using the retrieved metadata corresponding to the selected data of the hyperlink. The technology can copy at least one hyperlinked selected data to the path of the computer data container storing the central linking document.

In some embodiments, copying hyperlinked selected data to the path of the computer data container storing the central linking document includes copying the hyperlinked selected data to a subdirectory of the path. In some embodiments the technology can label hyperlink anchors in the central linking document using the retrieved metadata of the selected data corresponding to the annotated hyperlink anchor. In some of those embodiments, the technology enables editing of the anchor label. In some embodiments, the technology can annotate the hyperlink anchor in the central linking document using the retrieved metadata of the selected data corresponding to the annotated hyperlink anchor. Such an annotation can be adjacent the hyperlink anchor. In some embodiments, the annotation comprises information from at least one field from a database containing the selected data. In some embodiments, the annotation comprises information derived from at least one field from a database containing the selected data, e.g., derived by use of semantic analysis, derived by identifying words and phrases less likely to occur in a document. In some embodiments, the technology accepts edits to the annotation.

### BRIEF DESCRIPTION OF THE DRAWINGS

Reference will now be made, by way of example, to the accompanying drawings which show example embodiments of the present application.

FIG. 1 shows and exemplary process of the technology.

FIG. 2 illustrates an overview of data flows in a litigation hyperlink of the technology.

FIG. 3 illustrates methods of the technology.

FIG. 4-FIG. 6 illustrate an image sequence representing a multipage document in a litigation support database.

FIG. 7-FIG. 15 illustrate a user interface of the technology.

FIG. 16-FIG. 18 illustrate directory containing a central linking document and selected data subdirectories of the technology.

FIG. 19-FIG. 21 illustrate a central linking document of the technology containing a hyperlink anchor and annotation of the technology.

FIG. 22-FIG. 24 illustrate screens displayed as a result of selecting the hyperlink in the central linking document.

### DETAILED DESCRIPTION

Reference will now be made in detail to embodiments of the technology. Each example is provided by way of explanation of the technology only, not as a limitation of the technology. It will be apparent to those skilled in the art that various modifications and variations can be made in the present technology without departing from the technology. For instance, features described as part of one embodiment can be used on another embodiment to yield a still further embodiment. Thus, it is intended that the present technology cover such modifications and variations that come within the scope of the technology.

Information of all kinds is increasingly being created as or converted into computer data. This computer data is increasingly being stored or indexed in computer data containers such as computer files and databases. People who write electronic text documents increasingly need to be able to create informative hyperlinks from these electronic text documents to selected data from these computer data containers. (In this disclosure, an electronic text document containing hyperlinks is referred to as a “central electronic linking document.”) To create such informative hyperlinks, it is useful to be able to automatically retrieve (and in some embodiments, derive) information relating to the selected data, so that the information can be included in the central electronic linking document as an annotation to the hyperlink.

These people also need a way to be able to work collaboratively to write text that includes such hyperlinks. They also increasingly need to be able to create assemblies consisting of central electronic linking documents with annotated hyperlinks, together with the hyperlinked data, in a way that will make it easy to copy and distribute an assembly in its entirety. Finally, they also increasingly need to be able to author create electronic linking documents with annotated hyperlinks, in which the hyperlinks point to computer data containers at specific addresses on specific computer storage volumes.

The technology includes systems of interrelated operations for creating an annotated hyperlink, within the central electronic linking document, to computer data in a computer data container. A user of the technology, which may be a person or another computer process (a “User”), selects the computer data in the computer data container. Then, at the User's command, the technology automatically collects and derives information relating to the selected computer data. It can create a copied version of the selected computer data, which can involve modifications to or conversions of the copied computer data container, or the creation of an entirely new or different type of computer data container to contain the data selected. If it creates a copy of the data, it places the copy in a computer storage location appropriate to the type of hyperlink to be created. It inserts, in the central electronic linking document, a hyperlink to the data or the copy, along with annotations created from the information collected or derived. The visible text of the hyperlink can include such annotations.

Before the Automated Annotating Hyperlinker, creating annotated hyperlinks in central electronic linking documents was much more labor-intensive.

Examples of embodiments of the technology are set forth below. The details are provided only as examples, not as limitations on the technology. Various modifications and variations can be made in the technology without departing from the technology. For instance, features described as part of one embodiment can be used on another embodiment to yield a still further embodiment. It is intended that this application cover such modifications and variations that come within the scope of the technology.

Embodiments described below include a “litigation hyperlinker.” In some embodiments, the litigation hyperlinker is software written in Microsoft Visual Basic 6.0 (SP6) using Microsoft Visual Studio 6.0. It can use Microsoft's Component Object Model (“COM”) Automation technology; the Application Programming Interface (“API”) provided by litigation support database software called iBlaze, Version 2.9, licensed by CT Summation; programming interfaces provided by the API for Microsoft Word; standard Windows APIs; Windows scripting and file system methods and processes; and standard computer programming operations such as string searches. It also can use other COM objects and APIs. The following sections describe how it uses these technologies.

Here is a concrete example of what the litigation hyperlinker does:

In this example, a law firm has created a litigation support database in connection with a particular litigation. The database refers to many computer files. Any of these files may constitute or lead to evidence admissible in the litigation, or provide other relevant facts. To create the database, the attorney in charge of the litigation has used iBlaze.

In connection with the litigation, she is composing a brief that includes factual recitations, factual analyses, and factual arguments. She is composing the brief on a general purpose Intel-based x86 computer running the Microsoft Windows XP Pro operating system, and using Microsoft Word 2003. Her computer is connected to her law firm's local area network (“LAN”), and the brief is stored on a LAN storage volume that can also be accessed by her coworkers.

She is including in the brief hyperlinks to copies of some of the files in their entirety. She is also including hyperlinks to parts of other files, hyperlinks to sequences of image files that will need to be conjoined, and hyperlinks to PDF versions of various files. She will need the help of several people working at different computers on the law firm's network, who will be adding additional hyperlinks to the brief. The attorney will also provide other people with copies of the entire brief and the linked files so that they can review the entire assembly without using a network or telecommunications.

Here is how a litigation hyperlinker can operate in this scenario. The numbering is not meant to limit the technology in any way:

The User selects a file. The User uses one of iBlaze's built-in file viewers to view a file that is referenced in the iBlaze database. If the file is a transcript, the User can select a portion of it by highlighting it.

The User directs the litigation hyperlinker to retrieve information about the file. Having selected a file, the User then clicks a button on the litigation hyperlinker's user interface that invokes its information-retrieval function. In response, the litigation hyperlinker uses the iBlaze API to determine the type of file being viewed and to retrieve (and in some embodiments, derive) information about the file.

If the file is not a transcript, the litigation hyperlinker locates the iBlaze record relating to the file by using the iBlaze API to find the unique identifier associated with the file in the viewer. In iBlaze, the default name for this unique iidentifier is the “Docid.” It then uses the iBlaze API to search through iBlaze's “E-Table” until it finds the record with that Docid value. It then reads information from the other fields in that record. If the file is a transcript, the litigation hyperlinker uses the iBlaze API features that relate specifically to transcripts. In either case, the litigation hyperlinker uses iBlaze's API to retrieve the location of the file being viewed within the file system or network. As the examples below set forth more fully, the litigation hyperlinker retrieves different types of information depending on what types of information are available for the file.

Where a database record identifies a selected file or a collection of files as a numbered deposition exhibit, the litigation hyperlinker uses the iBlaze API to locate the directory that contains the transcripts in that case, and it scans the transcripts in that directory using string operations to attempt to find the cite(s) within the transcript(s) for the page(s) and line number(s) where the exhibit was marked.

Deposition transcripts—A User can view and select a portion of a deposition transcript using iBlaze and then activate the information-retrieval function of the litigation hyperlinker. In response, using the iBlaze API functions applicable to transcripts, and by reading the text file directly using standard Windows file system operations, the litigation hyperlinker can retrieve and display information that can include: the selected text; the name of the deponent; the date of the deposition; whether the deposition was videotaped; and the page and line numbers for the beginning and end of the selected portion.

Image files—Image files referred to in an iBlaze database can include native digital images and scanned versions of paper documents (text, images, and mixed foul's). The information that the litigation hyperlinker can retrieve depends on the type of image and what has been captured in the iBlaze database. For purposes of this example such information can include: original document type (digital photo; scanned photo, letter, spreadsheet, email, etc); image format (e.g., jpg, gif, tiff, bmp, etc.); summaries, analyses, notes, and commentary; subject; author and/or sender; recipients; creation date; last modified date title; issues; date sent; date received; Bates range; deposition exhibit number(s); transcript, page, and line citations to transcripts in which the exhibit was marked for identification; trial exhibit number(s); for image files representing scanned multi-page documents, total number of pages in the original document; and for image files representing scanned multi-page documents, information from which fully-pathed filenames of all files comprising the document can be derived.

Email—The litigation hyperlinker can retrieve the same information for email as is available for image files (except for information specific to images, such as image format). In addition, the litigation hyperlinker can retrieve the entire body of the email and, if the email is the sender's copy, the litigation hyperlinker can retrieve the names or email addresses of any bees.

Other computer files—The litigation hyperlinker can retrieve the same information for other computer files as is available for image files (except for information specific to images, such as image format). It can also retrieve the text of certain kinds of other computer files, such as Word and Excel files.

The litigation hyperlinker uses the information retrieved (and in some embodiments, derived) to draft the annotations that will appear in the brief. From this information, the litigation hyperlinker composes a draft version of the visible text of the hyperlink and of the accompanying annotation information and presents it as editable text on its user interface.

The User can edit these draft annotations. The User can use the interface provided by the litigation hyperlinker, and/or edit the annotations later using Word after the litigation hyperlinker has created the annotated hyperlink.

The User initiates the copying and linking process. Having made any edits to the annotation information retrieved or derived by the litigation hyperlinker, the User then clicks a button on the litigation hyperlinker's user interface that begins the copying and hyperlinking operations.

The litigation hyperlinker performs functions and provides options specific to the type of file.

If the file is a transcript, the litigation hyperlinker asks the User whether the copy should include the entire transcript or only the pages containing the highlighted portion. If the User wants the entire transcript copied, the litigation hyperlinker will use ordinary file system operations to copy the entire file. Otherwise, the litigation hyperlinker will read the original file using ordinary file system operations and create a new file limited to the first page of the transcript and the transcript pages containing the highlighted portion.

The litigation hyperlinker performs various image operations for multi-page image sequences.

The litigation hyperlinker uses string operations to determine which image files constitute a single document. A multipage document may consist of a single multipage image file, a collection of single-page image files, or a combination thereof. Using the iBlaze API, the litigation hyperlinker retrieves the database record for the image in the viewer that indicates which image files comprise the entire document. The litigation hyperlinker uses string operations to parse this field to determine which image files comprise the document.

The litigation hyperlinker can use FreeImage.dll to determine how many image pages are in each image file. FreeImage.dll (“FreeImage”) is open-source software available at http://fteeimage.sourceforge.net.

The litigation hyperlinker can permit the User to designate a range of pages from a multipage document for copying and linking. It does so using a simple pop-up form.

The litigation hyperlinker can use FreeImage to create a single tiff file for each page selected by the User. It can use FreeImage to do so, to rotate images to portrait mode, and to apply a compression method appropriate to the type of image. These single page image files can be stored in a temporary directory until they are no longer needed.

The litigation hyperlinker joins the first page of the multipage document and the range of pages designated by the User into a single multipage tiff image file, so that a single hyperlink can link to the entire range. It can do so using a function built in to the iBlaze API.

The litigation hyperlinker can determine the appropriate subdirectory for the copy or modified copy of the file and constructs an appropriate name for it. The litigation hyperlinker can place the copy or modified copy of the file into the appropriate subdirectory of the directory that the brief is in. Copies of emails can go into the Email subdirectory; copies of images can go into the Image subdirectory, etc. If the subdirectory does not already exist, the litigation hyperlinker can create it.

The litigation hyperlinker can construct a new name for the copy. For all types of files except transcripts, the beginning of the new name can be a unique identifier such as “Docid” in an iBlaze database. The beginning of the names of files derived from transcripts can be the un-pathed file name of the transcript without the extension. Where a copy represents part of a larger document (e.g., where the User has elected to copy only certain pages from a transcript or multipage image), the page range of the included pages can be appended to the Docid or transcript name. In any event, the extension can be appended to the file name depending on the file type. In some embodiments, the file type will be the same type as the original file, except that a set of single-page image files can be converted to multipage tiff files and emails can be copied as htm files.

The litigation hyperlinker can create the copy or modified copy of the file with the new name at the appropriate location.

If the User has software installed on her computer that can create a PDF version of the particular file type, the technology can offer the User the options a) to create a PDF version of the file, and b) to hyperlink the central electronic linking document to the previously-copied file or to the PDF.

The method used to create a PDF version of a file depends on the file type and the software available on the User's computer.

The technology can create PDF versions by automating the following components using the APIs provided by those components: a) a commercially available programmable PDF conversion component; b) FreeImage; c) Microsoft Word, Excel, or PowerPoint; and d) OpenOffice.org Writer, Calc, Impress, or Draw.

Certain types of image files, including multipage TIFF files, can be converted directly to PDF using only the commercial PDF component without any other software. For these files, the technology can use the API of that commercial PDF component to direct that component to create the PDF version of the file. Certain other types of image files can be converted into an intermediate format before the technology can use the commercial PDF component to create a PDF version of the file. For such file, the technology can use the FreeImage API to perform the initial conversion and the API of the commercial PDF component to create the PDF version of the file.

Certain other types of image files cannot be converted using the commercial PDF component, either alone or in conjunction with FreeImage. If the image file can be opened in OpenOffice.org Draw or Impress, the technology can use the OpenOffice.org API to direct that component open the file and to then use the Export function of that component to export the file as a PDF.

If a non-image file can be opened in OpenOffice.org Writer, Calc, or Impress, the technology can use the API of the appropriate component to direct that component to open the file and to then use the Export function of that component to export the file as a PDF. If a non-image file can be opened in Microsoft Word, Excel, or PowerPoint, the technology can use the API of the appropriate component to direct that component to open the file and to then use the Print function of that component to print the file to a PDF using the API of the commercial PDF component.

The litigation hyperlinker can place the PDF version in the appropriate subdirectory of the directory containing the brief. The litigation hyperlinker can insert an annotated relative hyperlink to the copy or PDF, along with the other annotation information, into the brief. The litigation hyperlinker can create a “relative” hyperlink and uses the “file:” linking syntax (as opposed to, for example, “http:”). It can use Microsoft's Word Visual Basic for Applications API to do so.

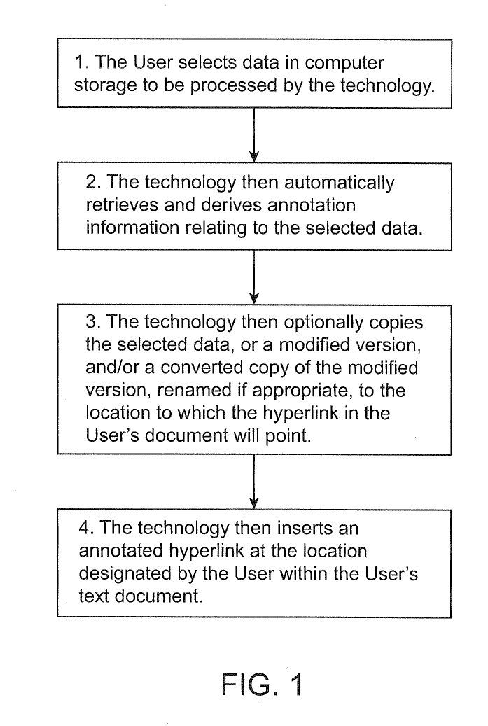

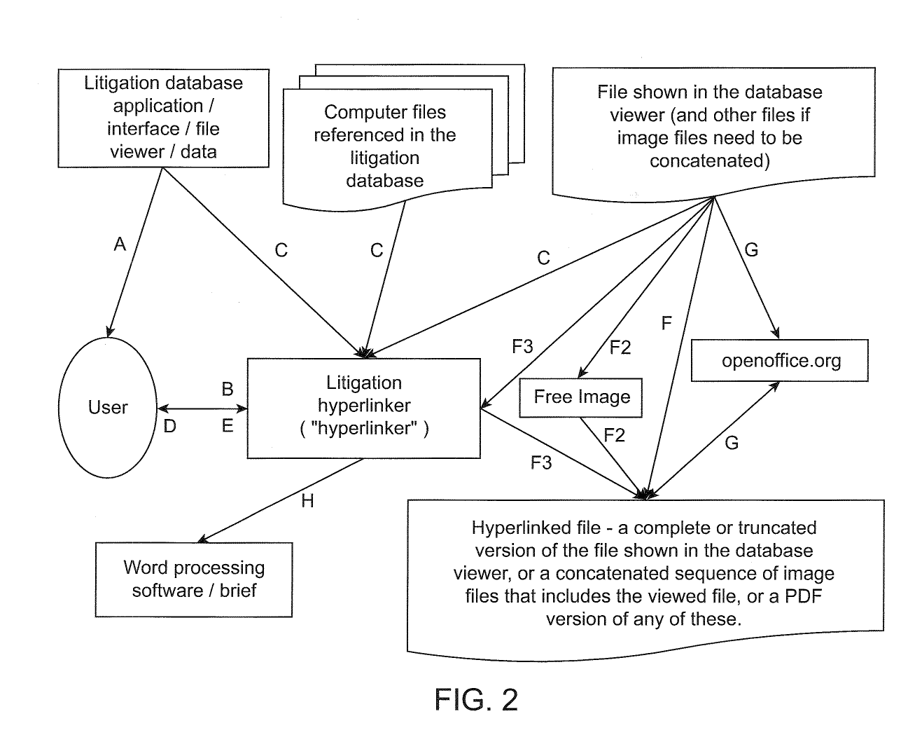

Referring to FIG. 1 and FIG. 2, an overview of dataflow in a litigation hyperlink of the present technology is shown. In FIG. 2, at A a User identifies a file to be hyper linked by viewing it in the litigation database application file viewer 1. At B, the User activates the hyperlinker's information-retrieval function. At C, the hyper linker retrieves and derives information relating to the file 2. At D, the hyper linker presents the information to the User for editing. At E, a User optionally edits the information and tells the hyperlinker to begin the copying and hyperlinking sequence. The User tells the hyperlinker whether she wants the entire file copied or selects a part of it; if the file is part of a sequence of image files, what part of the sequence she wants to concatenate and include; whether she also wants a PDF version; and whether she wants the hyperlink to point to the PDF. At F, depending on file type and the User's choices, the hyperlinker will: F1 direct the file system to copy and rename the file; F2 uses FreeImage to create a concatenated renamed copy; or F3 uses file system and string operations to create a truncated copy 3. At G, depending on the User's choices, the hyperlinker can make a PDF copy. If original copy is not a multipage image, the hyperlinker directs OpenOffice.org to open the newly-made copy and export it as a PDF. Otherwise, the hyperlinker directs OpenOffice.org to create an image sequence from image files in a temporary directory and export to PDF. At H, the hyper linker directs the word-processing software to insert the hyper link into the brief at the point indicated by the User 4.

Some embodiments of the technology create hyperlinks to specific storage locations, sections, or ranges within a hyperlinked file. Some embodiments of the technology copy and hyperlink to data in other types of computer data containers in addition to computer files. Some embodiments of the technology retrieve or derive information relating to the file from any sort of litigation support database (i.e., not just from iBlaze but also, e.g., from Concordance or CaseMap). Some embodiments of the technology retrieve or derive information relating to the file without using COM. In some embodiments, the electronic central linking document is not a legal brief, but can be any other type of electronic central linking document to be used for any purpose.

Some embodiments of the technology retrieve or derive information relating to the file from any sort of database (i.e., not just from litigation support databases). Some embodiments of the technology retrieve or derive information relating to the file by using existing APIs of applications designed to open and read such files. Some embodiments of the technology retrieve or derive information relating to the file by using newly-created or special-purpose APIs of applications designed to open and read such files. Some embodiments of the technology retrieve or derive information relating to the file by using information about the format and structure of files like the file to read the file without using any other application. Some embodiments of the technology retrieve or derive information relating to the file from any type of computerized data source. Some embodiments of the technology retrieve or derive information relating to the file by using any types of information retrieval technology, including but not limited to full Boolean search, semantic search, conceptual clustering, timeline analysis, link analysis, and social network analysis. Some embodiments of the technology include a cleanup function to enumerate the files in the assembly and match them against the hyperlinks in the central electronic linking document so that, if a hyperlink has been deleted and no hyperlinks to a particular file remain, the cleanup function will delete the formerly-linked file. Some embodiments of the technology allow the User to select a file for hyperlinking using any selection means known to those skilled in the art, in addition to those described herein, such as by opening, selecting, or viewing it in any application or in any file system, network, intranet, or Internet browser, or by selecting a database record referring to the file, or by selecting another representation of or reference to the file. Some embodiments of the technology determine which file the User intended to select by presenting the User with a categorized pick list of all media files (text, graphics, data, audio, video, multimedia, etc) currently open in whole or in part in her computer's system memory.

Some embodiments of the technology run on general-purpose or special purpose computers. Some embodiments of the technology run on computers using different types of central processing units. Some embodiments of the technology run on computers using different types of operating systems. Some embodiments of the technology use other image-manipulation libraries or applications (i.e., not just FreeImage) or include their own image-manipulation functions. Some embodiments of the technology use other PDF-creation libraries or applications (i.e., not just OpenOffice or a commercially available programmable PDF component) or include their own PDF-creation functions. Some embodiments of the technology operate in conjunction with other text-editing programs to compose the central linking document (i.e., not just Microsoft Word). Some embodiments of the technology perform any of its functions on any type of computer network or combination of networks. Some embodiments of the technology create relative hyperlinks, absolute hyperlinks, or other existing or future types of hyperlinks. Some embodiments of the technology create hyperlinks that invoke different existing or future communication protocols (e.g., “file:” “http:” etc.). Some embodiments of the technology permit extensive customization of options and preferences, either globally, or on a document-by-document, or file-by-file, or hyperlink-by-hyperlink basis. Some embodiments of the technology permit conversion of the file into other existing or future file formats in addition to PDF. Some embodiments of the technology expose their own APIs so that the technology be integrated with other data processing applications. Some embodiments of the technology be written in other programming and/or scripting languages using any development environment or any other programming technology. Some embodiments of the technology provide a text box containing the text of the underlying hyperlink, to be copied and pasted into central electronic linking documents being edited in text-editing applications that do not provide for automated insertion of hyperlinks. Some embodiments of the litigation hyperlinker retrieve the contents of other database fields in addition to those enumerated above, including custom fields created by iBlaze users. Some embodiments of the technology can be applied to any additional type of computer-readable data, including but not limited to audio and video.

For transcripts, some embodiments of the litigation hyperlinker retrieve annotations and comments relating to the selected portion and information in the database about any exhibits marked or referenced in the selected portion. Some embodiments permit the User to include only the selected text, or to include a certain number of words, characters, or pages before and/or after the selection. Some embodiments of the litigation hyperlinker retrieve a list of deposition witnesses referring to a file or the paper document represented by the file, with transcript, page and line citations; annotations about database records referring to the file; cross-references to and from database records referring to the file; database records for attached and attaching files; and Optical Character Recognition versions of scanned text files. For a “native” file, i.e., a file that was originally created to be used in the form of a computer file, and not as a replica of a non-digital object, some embodiments of the litigation hyperlinker also retrieve the following types of information by opening the files using the API of the type of application that created it, or by reading the information directly from the digital file itself if the file format is known. For example, for a native version of a word-processing document created in Microsoft Word or a spreadsheet created in Microsoft Excel (each of which is accessible through the Visual Basic for Applications API), some embodiments of the litigation hyperlinker also retrieve: • total number of revisions; • total editing time; • time and date last printed; • when the file was first created; • when the file was last saved; and • who last saved the file.

Similarly, some embodiments of the litigation hyperlinker provide that, if the email was extracted by iBlaze from a Microsoft Outlook PST file and the User has Outlook installed on her computer and a copy of the PST, the litigation hyperlinker uses Outlook's API to extract the email from the PST as a msg file, which includes all header information.

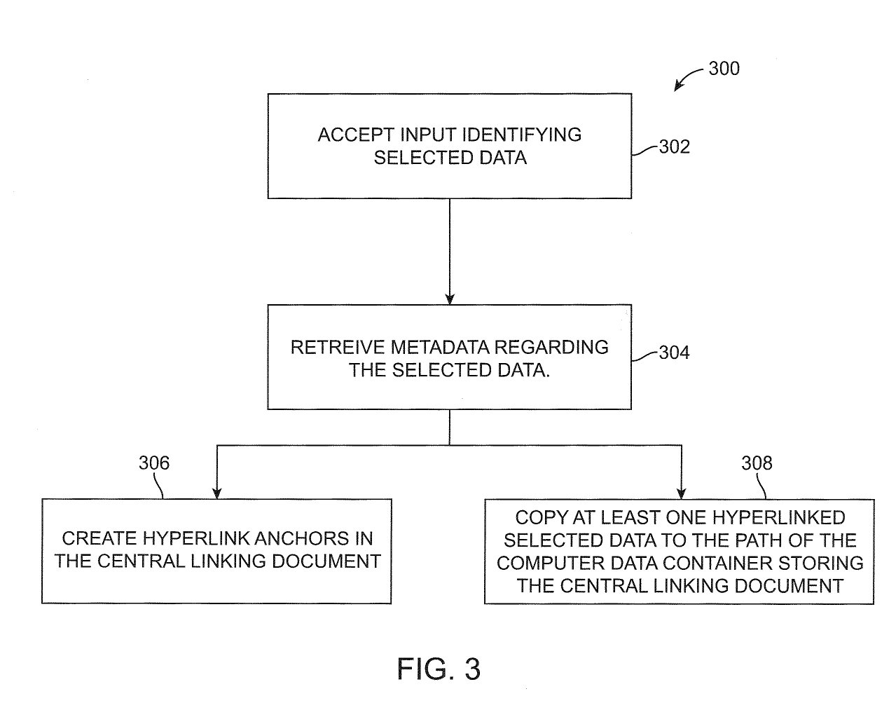

Referring to FIG. 3, methods 300 of the technology are shown. In a central linking document stored in a computer data container, the technology can accept input identifying selected data 302. Metadata regarding the selected data can be retrieved 304, e.g., from a computer data container storing the selected data. Such a computer data container can be a litigation database. The technology can also derive metadata from other sources. The technology can create hyperlink anchors containing the metadata and can insert other descriptive information containing the metadata in the central linking document 306. The hyperlink anchors are directed to the selected data using the retrieved metadata corresponding to the selected data of the hyperlink. The technology can copy at least one hyperlinked selected data to the path of the computer data container storing the central linking document 308.

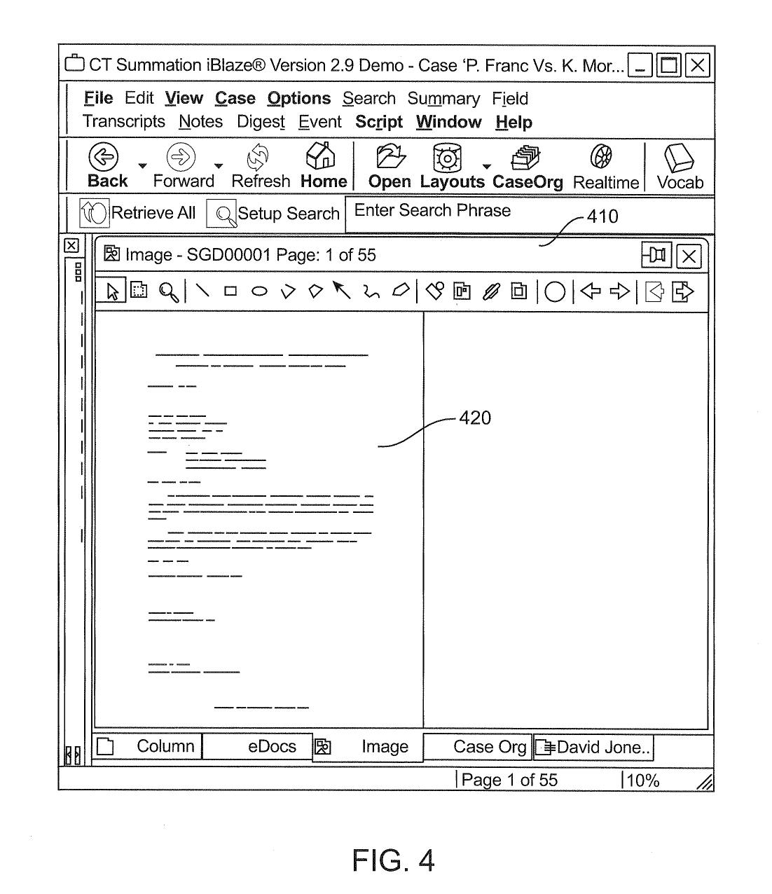

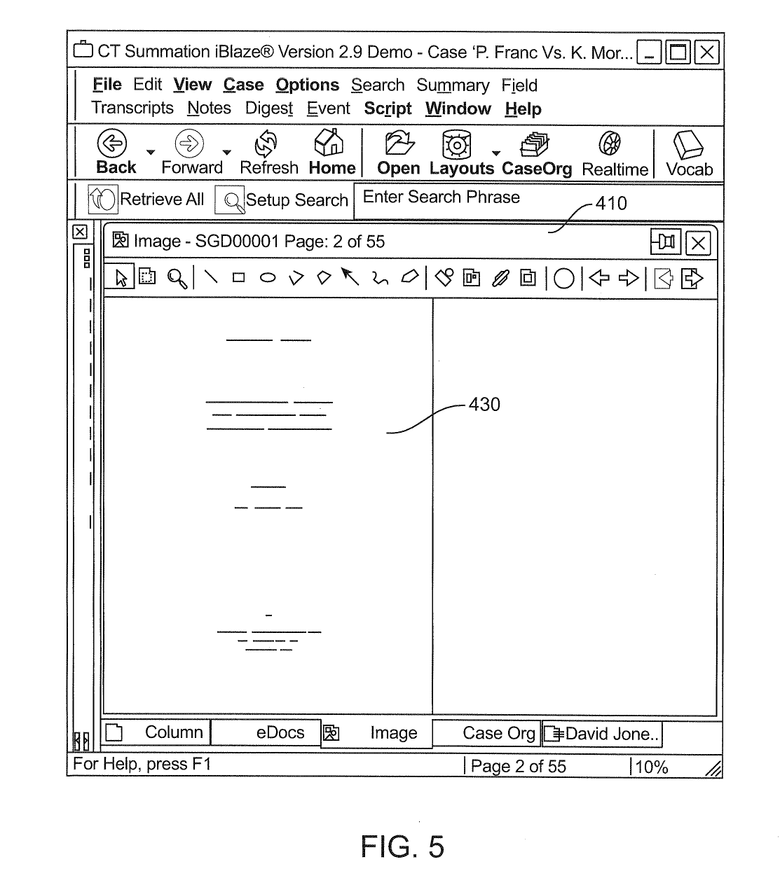

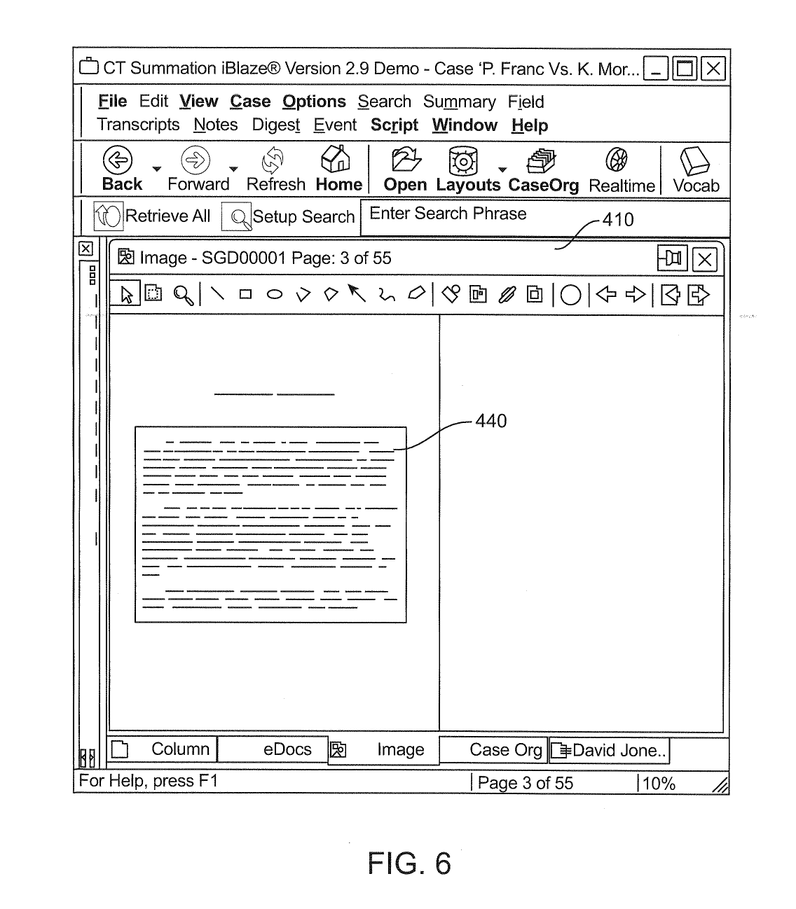

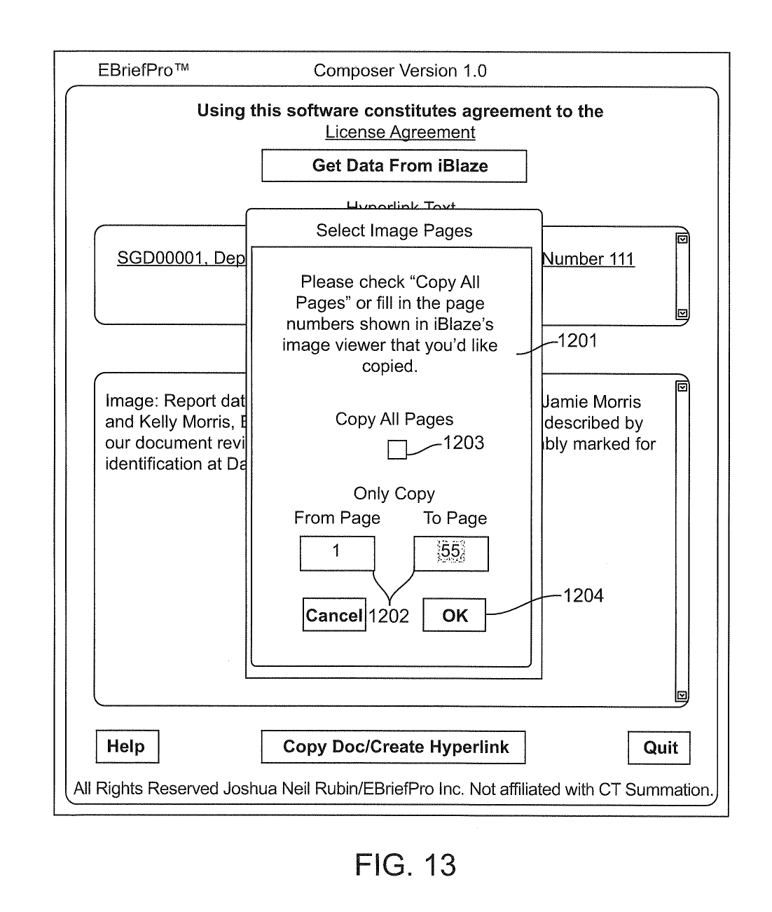

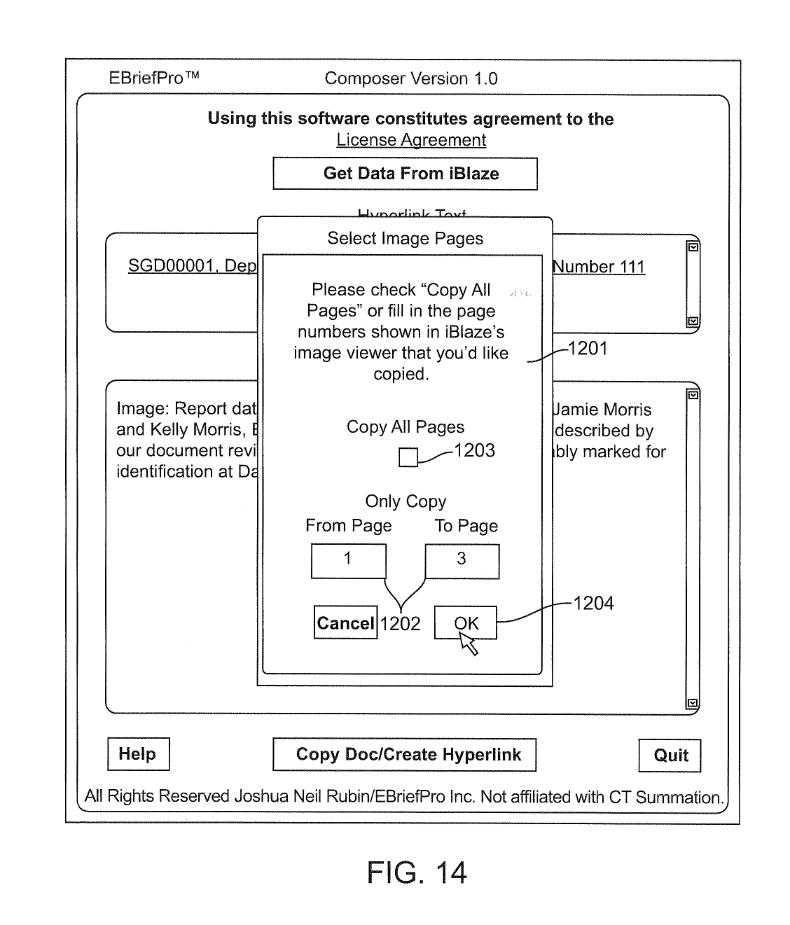

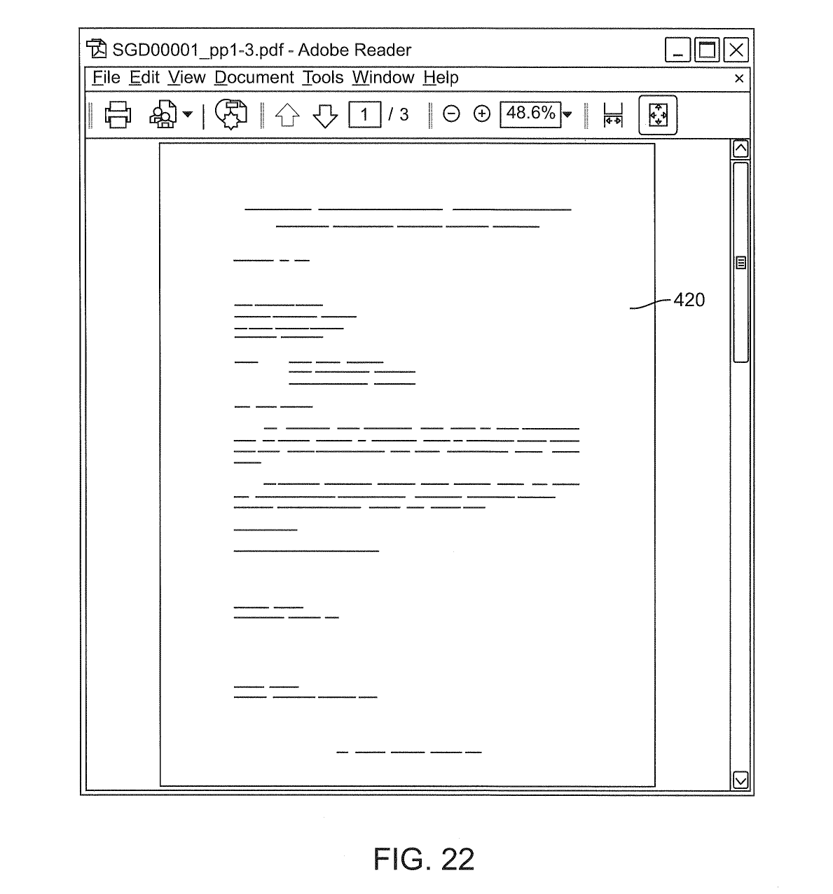

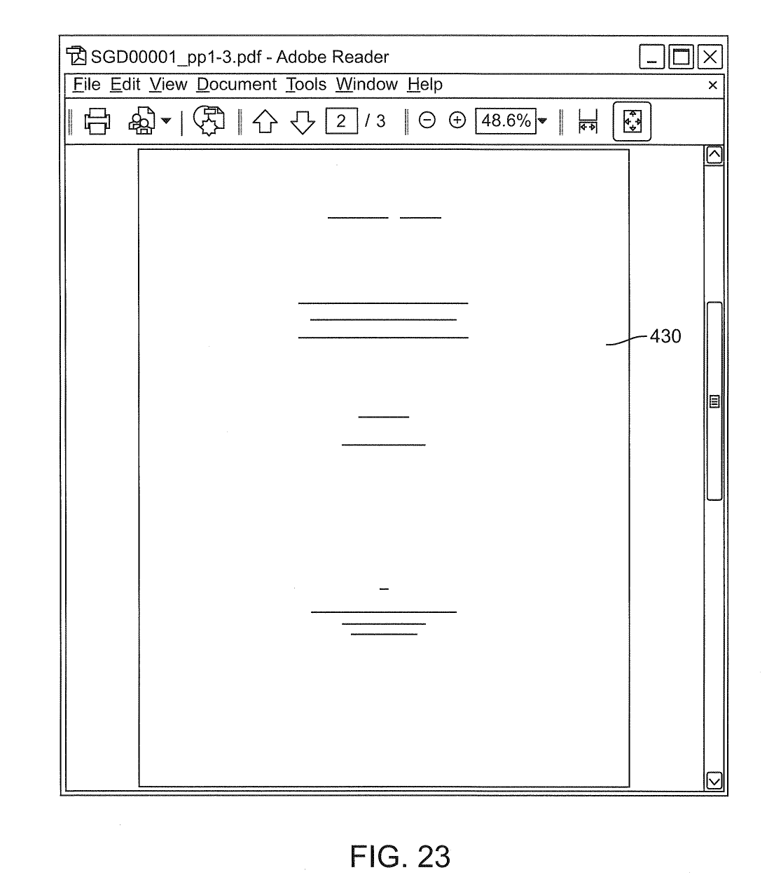

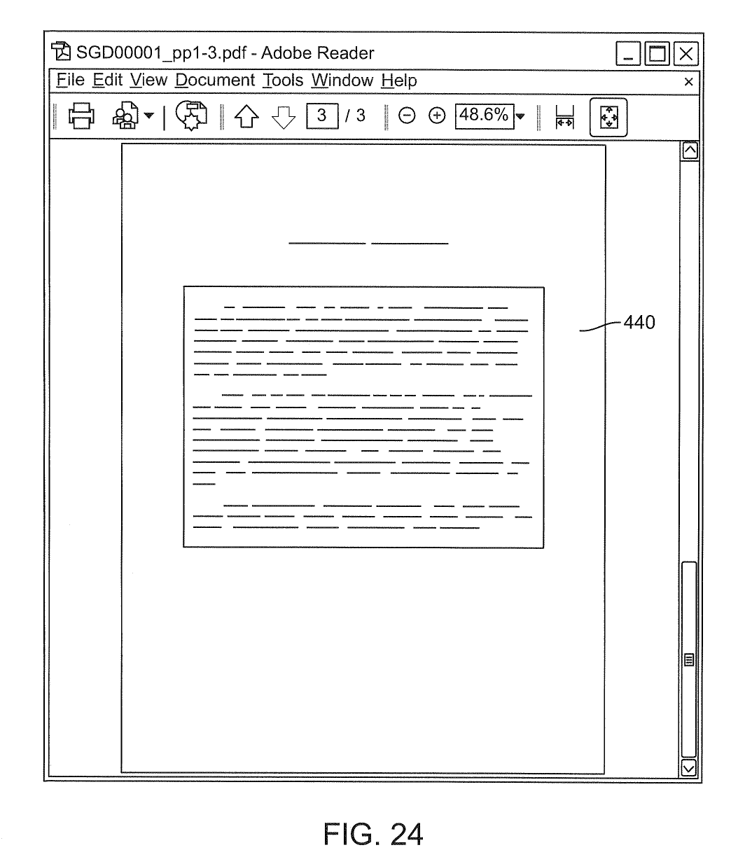

FIG. 4-FIG. 24 illustrate an exemplary sequence of how some embodiments of the technology can be used in connection with an image sequence.

In FIG. 4-FIG. 6, the User is viewing an image sequence that represents a multipage document using an image viewer 410 included in a litigation support database program called iBlaze, licensed by CT Summation. The iBlaze database contains information about the image sequence shown in the viewer. The information in the database includes both objective and subjective information. The User decides that she wants to describe and hyperlink part of this image sequence, e.g., 420, 430, 440 within the central electronic linking document, in this case a word-processed legal brief.

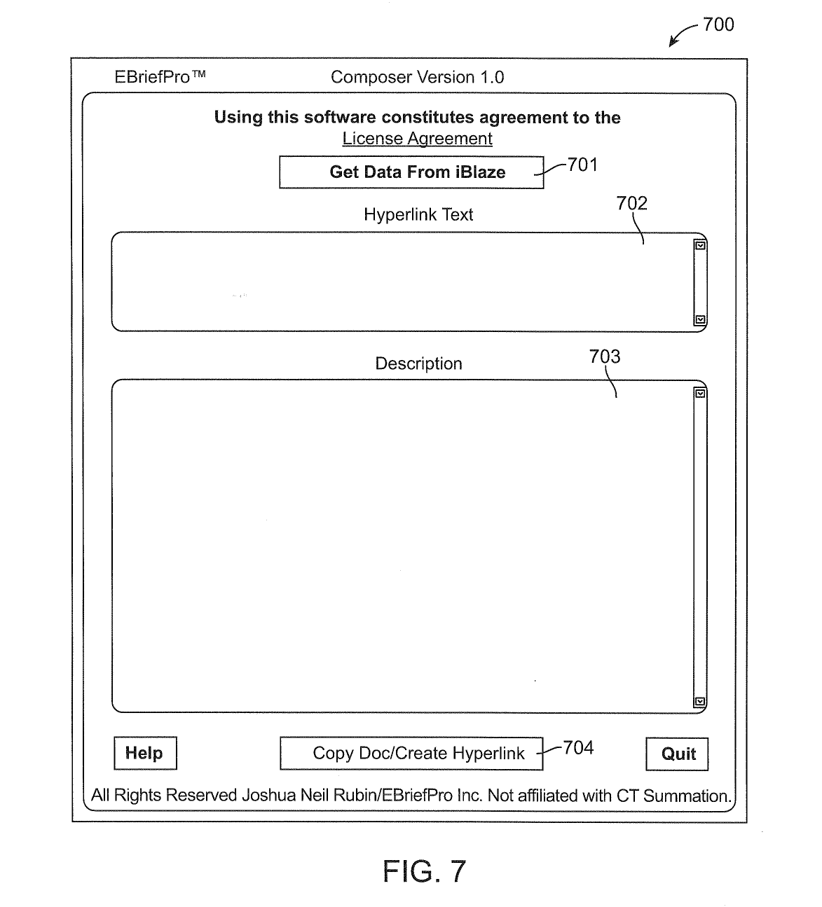

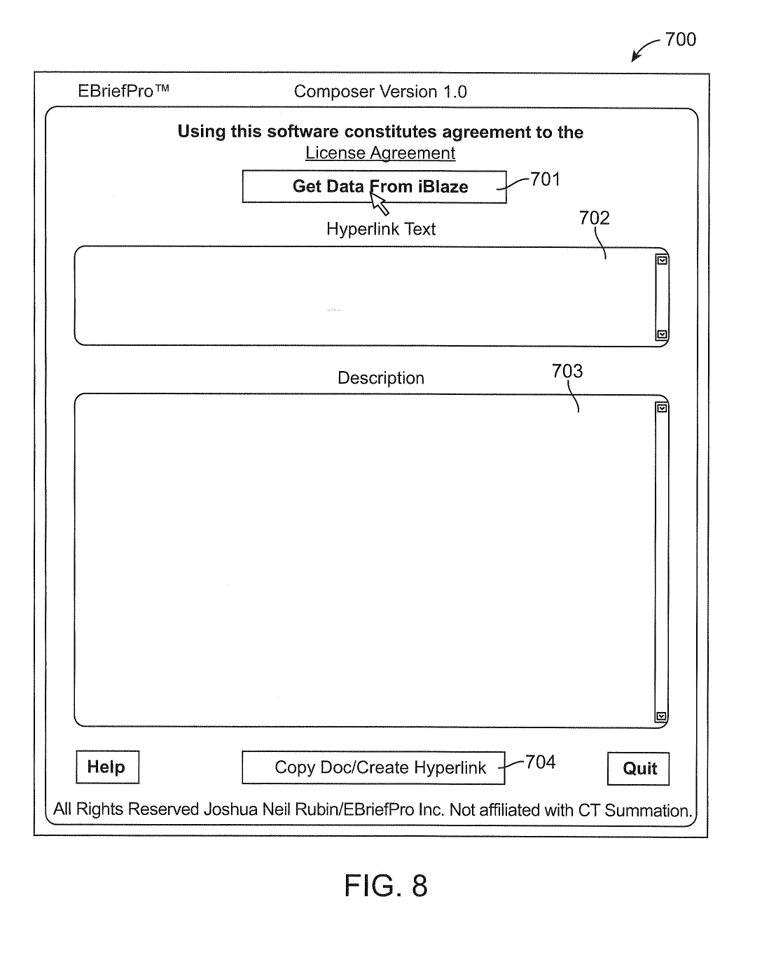

FIG. 7 illustrates an example of a litigation hyperlinker user interface 700. Part 701 is a command button that the User may use to command the litigation hyperlinker to obtain and derive information about the image sequence. Part 702 is a text box in which the litigation hyperlinker can present an editable draft version of the visible text of the hyperlink, created from the information to be obtained (and in some embodiments derived) by the litigation hyperlinker. Part 703 is a text box in which the litigation hyperlinker can present an editable draft version of annotation information relating to the file. Part 704 is a command button that the User may use to command the litigation hyperlinker to start the copying, linking, and annotating process. In FIG. 8, the User has indicated Part 701 (the “Get Data From iBlaze” button).

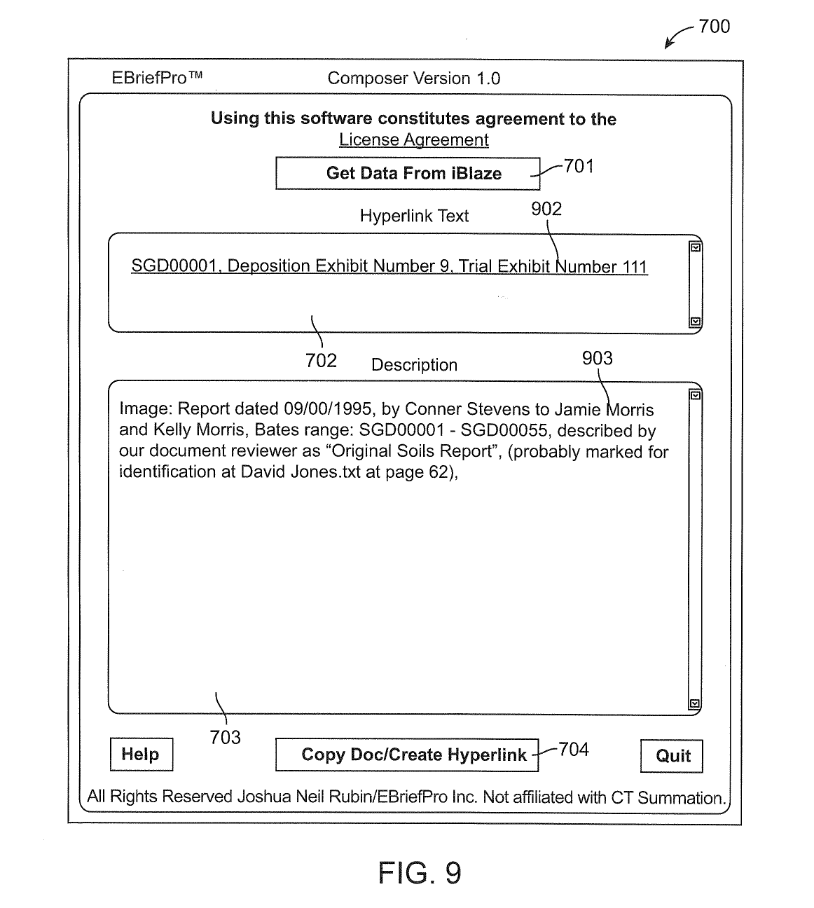

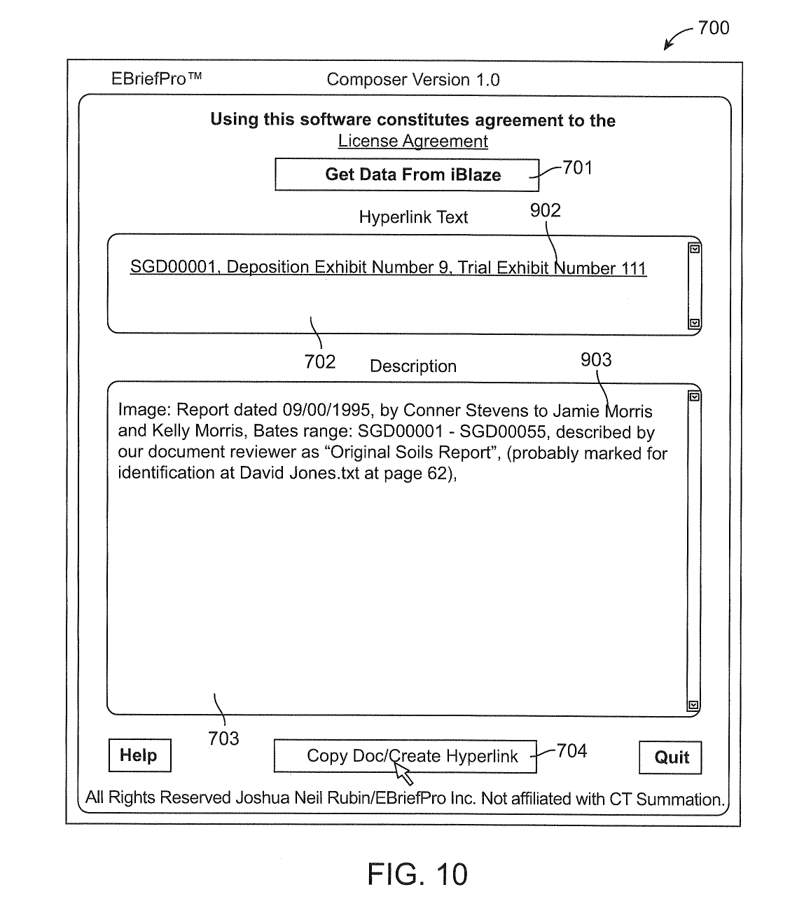

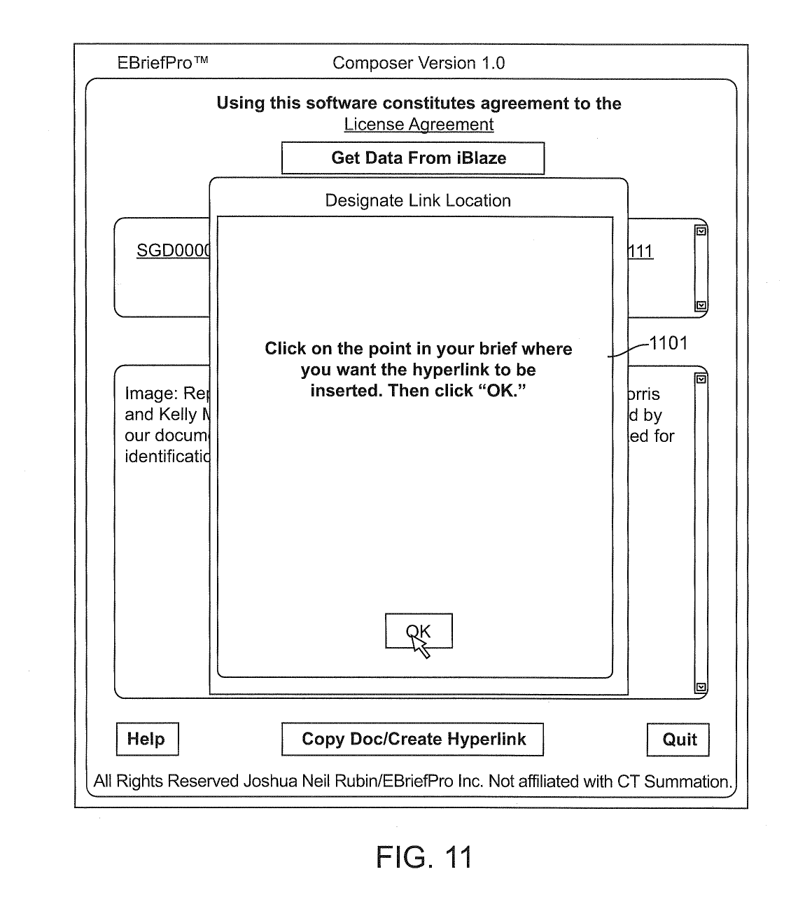

In FIG. 9, the litigation hyperlinker has obtained information relating to the image sequence from the iBlaze database, e.g., hyperlink text 902 in window 702. It has also derived information, e.g., 903 in window 703, about the image sequence by analyzing the text of the transcripts catalogued in iBlaze to determine where the image sequence was marked for identification. It is presenting this information in the two text boxes, Parts 702 and 703. The User can edit this information in the user interface of the litigation hyperlinker, or later in the word-processing program. In FIG. 10, the technology is receiving the copying/hyperlinking/annotating command via a user pressing the “Copy File/Create Hyperlink” button, Part 704. In FIG. 11, the technology is prompting the User, using window 1101 to designate the document and the location therein for the annotated hyperlink.

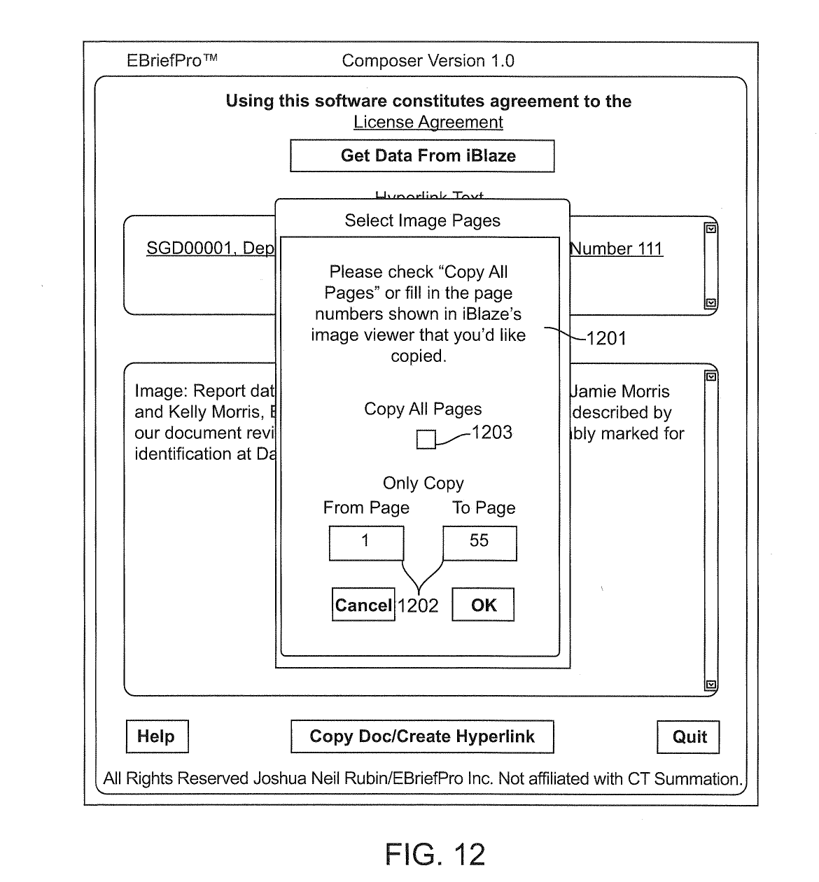

In FIG. 12-FIG. 14, the technology is prompting the User with window 1201 to designate the pages within the image sequence to be copied and hyperlinked to the central linking document; and the User is performing the designation, e.g., in boxes 1202 for page ranges, or box 1203 for all pages, and clicking “OK” 1204 to direct the litigation hyperlinker to proceed with pages 1-3. In some embodiments, non-consecutive pages can be indicated, e.g., “1, 3, 5, 23.”

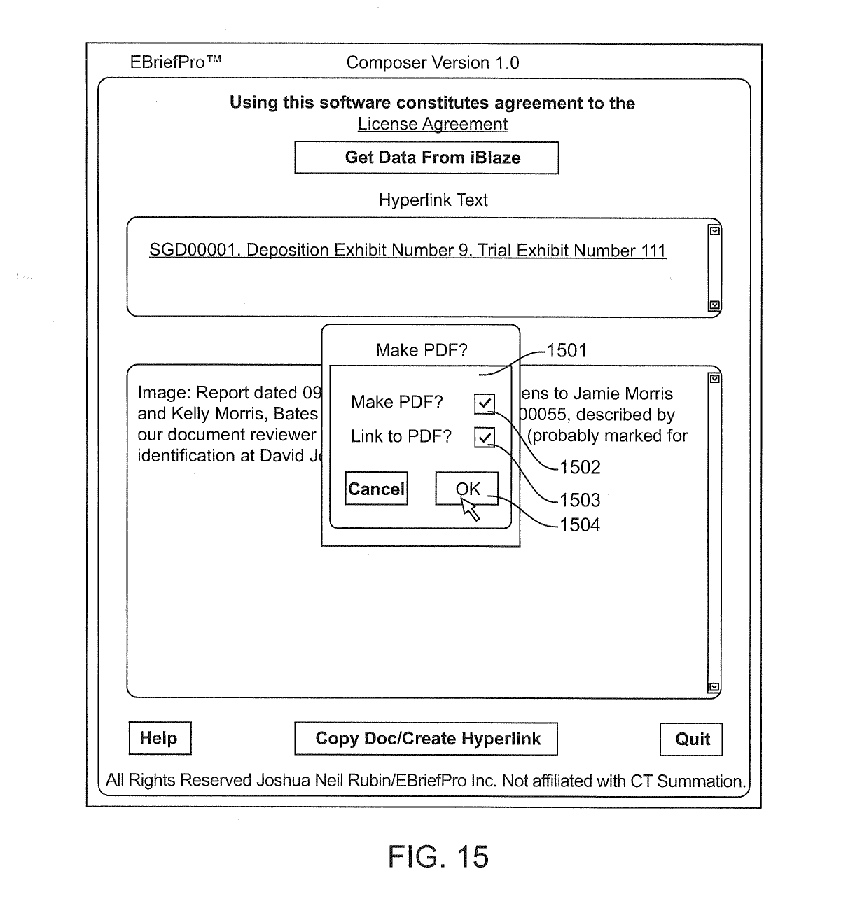

In FIG. 15, the technology presents the User with choices in window 1501: whether to create a PDF version of the file, box 1502 and, if so, whether the hyperlink in the central linking document should link to the original copy or to the PDF version box 1503. The technology accepts user input (boxes 1502 and 1503 checked, and button “OK” 1504 selected) indicating that the User has decided to create a PDF version and to direct the litigation hyperlinker to hyperlink the PDF version (not the original copy) to the central linking document.

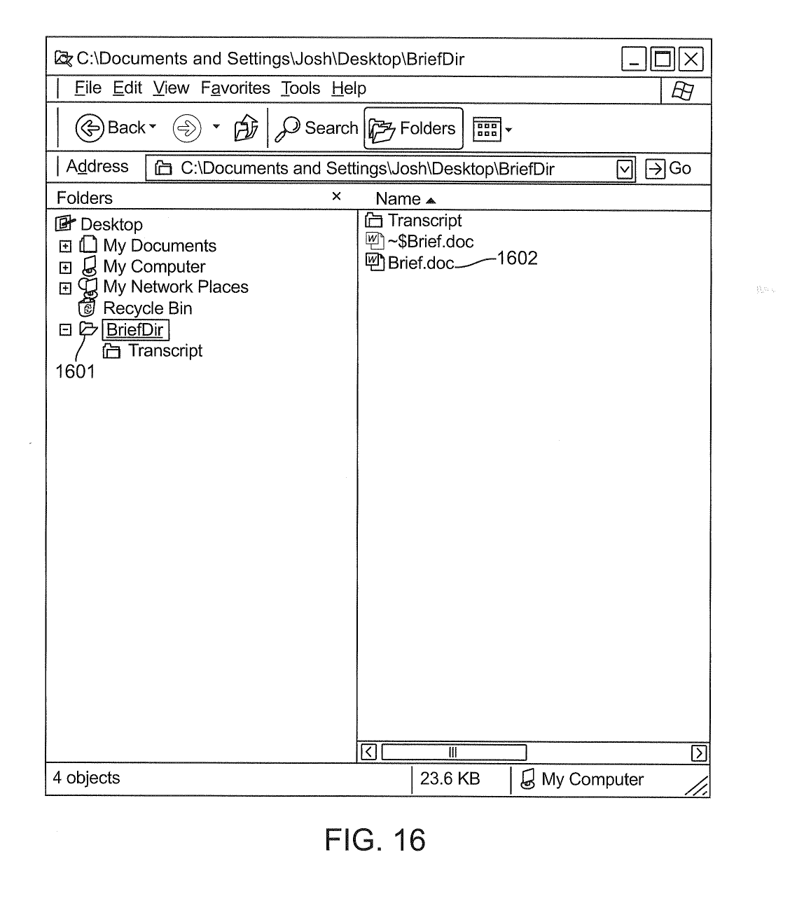

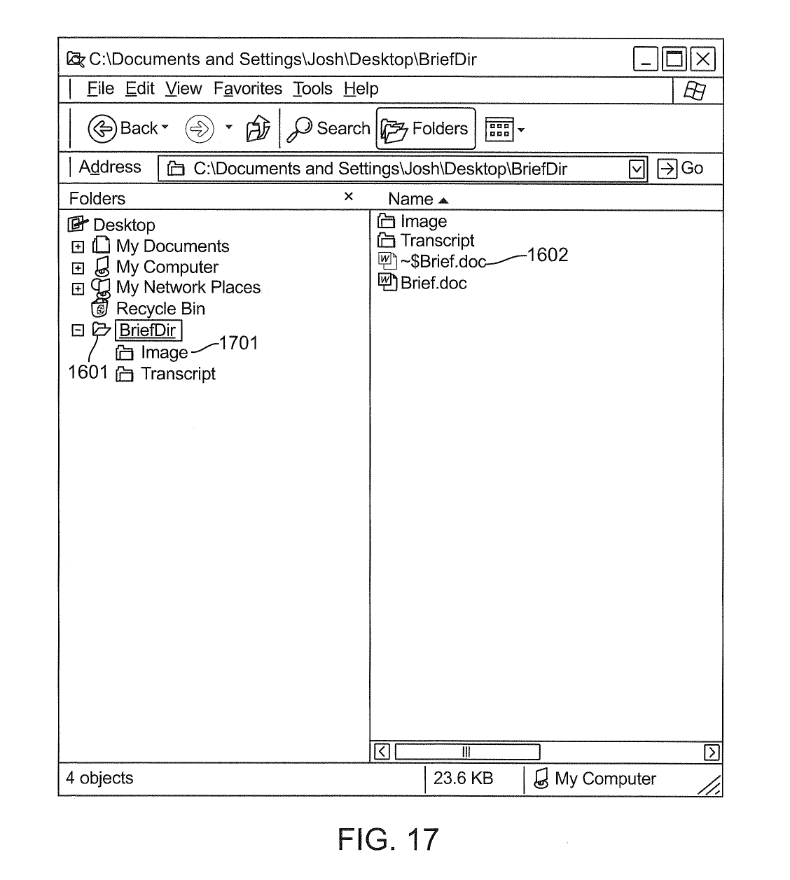

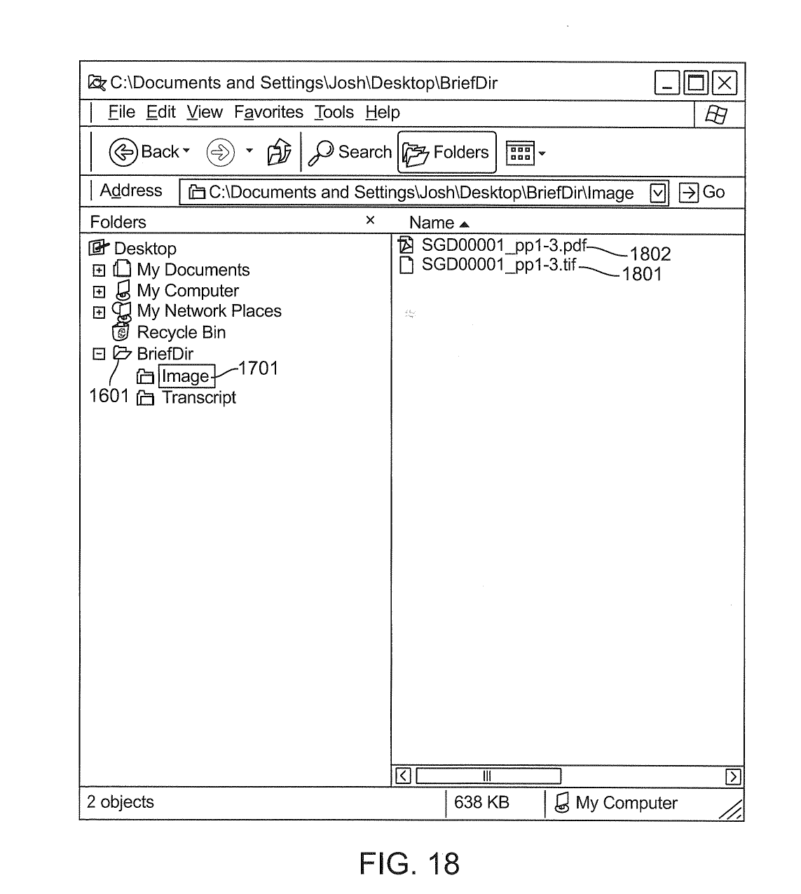

FIG. 16 shows the directory 1601 containing “brief.doc” (the central linking document) 1602. FIG. 17 shows that, as part of the copying and hyperlinking function, the litigation hyperlinker has created a new “Image” subdirectory 1701 of the directory containing the central linking document 1602. FIG. 18 shows that the technology has created a native copy 1801 and a PDF version 1802 of the image sequence in the new Image subdirectory 1701. The filenames include the litigation production designation of the first page of the image sequence (“SGD00001”) and another string (“_pp1-3”) signifying which pages from the sequence are included in the file.

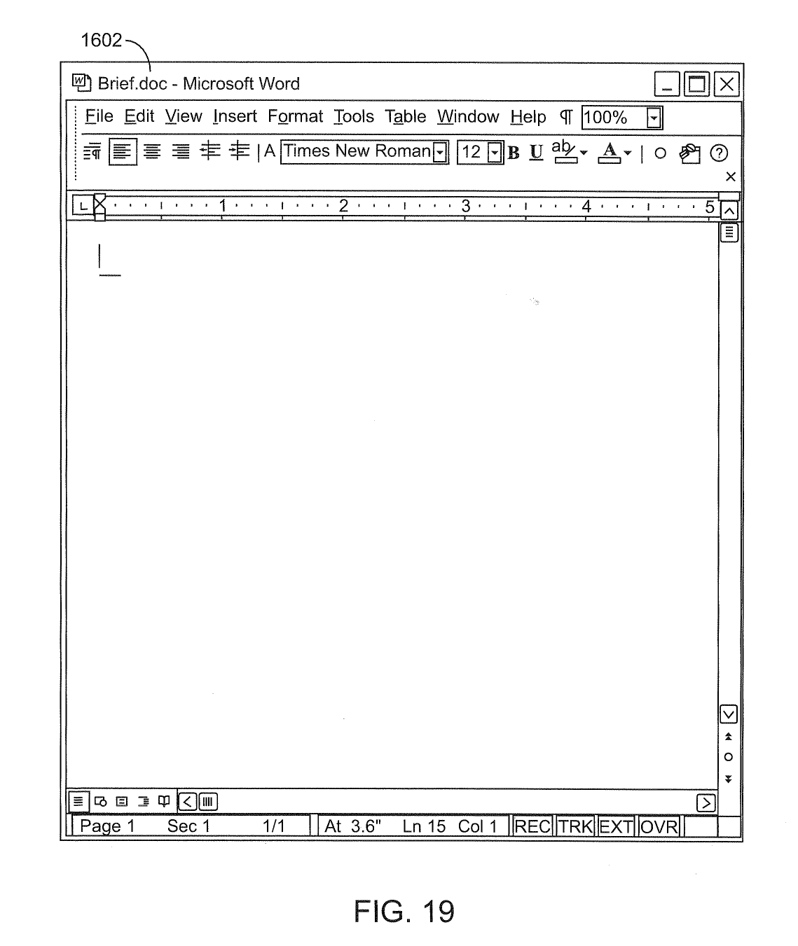

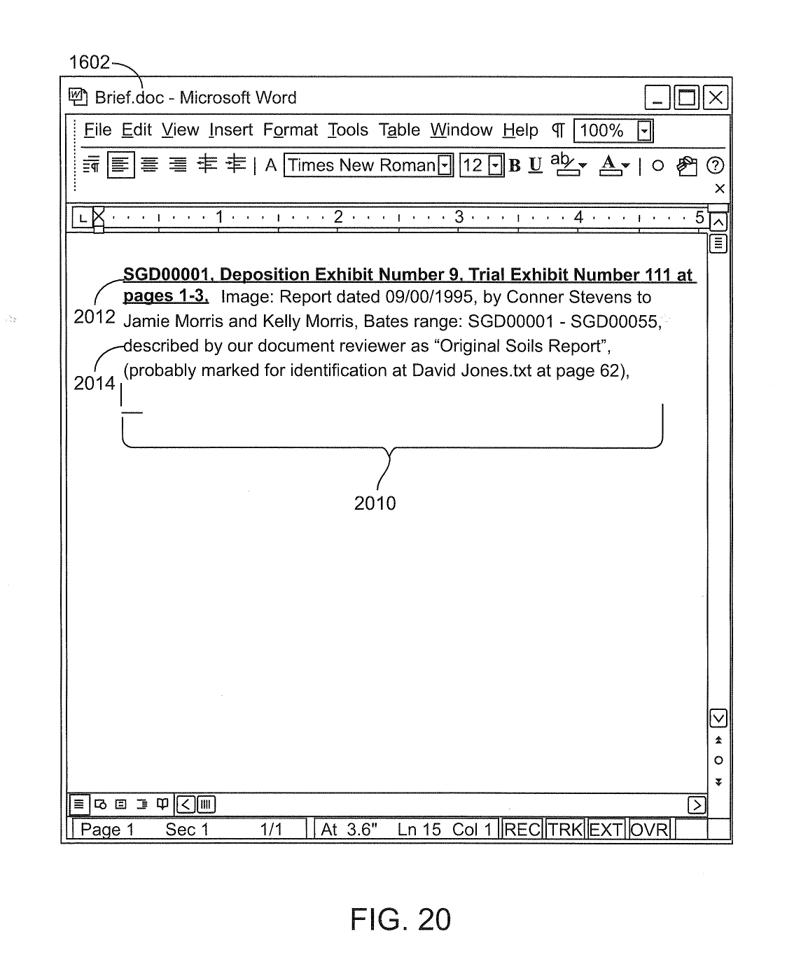

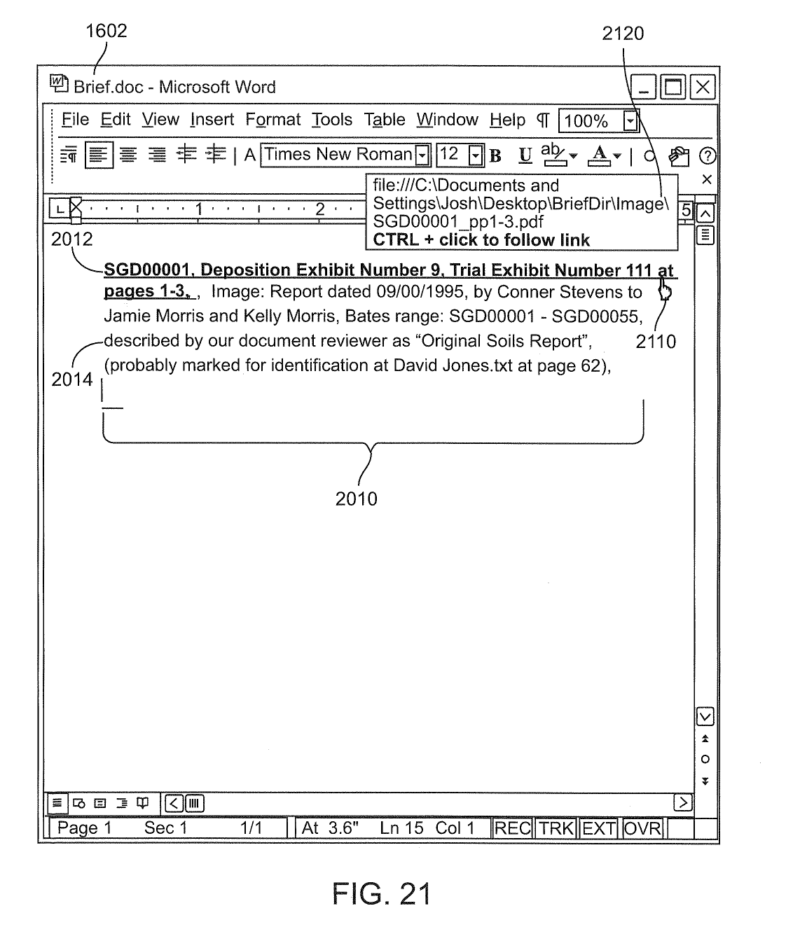

FIG. 19 shows “brief.doc” 1602 open in Microsoft Word before the technology has added the annotated hyperlink. FIG. 20 shows “brief.doc” 1602 open in Microsoft Word after the technology has added the annotated hyperlink 2010 including the hyperlink anchor and label 2012, and annotation 2014. FIG. 21 shows that when a cursor is positioned over the hyperlink, Microsoft Word can change the cursor to a hyperlink pointer 2110 and show an information window 2120 indicating that the hyperlinked file can be opened by clicking the hyperlink while holding down the Control key. FIG. 21-FIG. 24 illustrate the result of Control-clicking on the hyperlink in this example embodiment: the PDF version of the selected pages have been opened in Adobe Reader.

While described herein in part from the perspective of a user, the technology can be implemented as a method, system, and computer program product in part responding to user inputs and controls. E.g., where the disclosure recites “the user can edit,” it is an embodiment of the present technology that can make this functionality available to a user and accept inputs (directly from a user, or otherwise).

The features and embodiments described herein are intended to be exemplary, not exhaustive.

The technology can take the form of hardware, firmware, software, or a combination thereof. Furthermore, the technology can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium (though propagation mediums in and of themselves as signal carriers are not included in the definition of physical computer-readable medium). Examples of a physical computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R1W) and DVD. Both processors and program code for implementing each as aspect of the technology can be centralized or distributed (or a combination thereof) as known to those skilled in the art. A data processing system suitable for storing program code and for executing program code will include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

1. A computer-implemented method for creating a document assembly, the method comprising:
in a central linking document stored in a computer data container, accepting input identifying at least one selected data;
retrieving metadata regarding at least one identified selected data;
creating at least one hyperlink anchor in the central linking document to at least one identified selected data using its corresponding retrieved metadata; and
copying at least one hyperlinked selected data to the path of the computer data container storing the central linking document.

2. The method of claim 1, wherein copying at least one hyperlinked selected data to the path of the computer data container storing the central linking document comprises:
copying the at least one hyperlinked selected data to a subdirectory of the path.

3. The method of claim 1, further comprising:
labeling at least one hyperlink anchor in the central linking document using the retrieved metadata of the selected data corresponding to the annotated hyperlink anchor.

4. The method of claim 2, further comprising:
accepting edits to the anchor label.

5. The method of claim 1, further comprising:
annotating at least one hyperlink anchor in the central linking document using the retrieved metadata of the selected data corresponding to the annotated hyperlink anchor.

6. The method of claim 5, wherein:
the annotation comprises information from at least one field from a database containing the selected data.

7. The method of claim 5, wherein:
the annotation comprises information derived from at least one field from a database containing the selected data.

8. The method of claim 5, further comprising
accepting edits to the annotation.

9. A computer program product for creating a document assembly, the computer program product comprising:
a least one computer readable medium; and
at least one program module,
stored on the at least one medium, and
operative, upon execution by at least one processor for:
in a central linking document stored in a computer data container, accepting input identifying at least one selected data;
retrieving metadata regarding at least one identified selected data;
creating at least one hyperlink anchor in the central linking document to at least one identified selected data using its corresponding retrieved metadata; and
copying at least one hyperlinked selected data to the path of the computer data container storing the central linking document.

10. The computer program product of claim 9, wherein copying at least one hyperlinked selected data to the path of the computer data container storing the central linking document comprises:
copying the at least one hyperlinked selected data to a subdirectory of the path.

11. The computer program product of claim 9, further comprising:
labeling at least one hyperlink anchor in the central linking document using the retrieved metadata of the selected data corresponding to the annotated hyperlink anchor.

12. The computer program product of claim 9, further comprising:
annotating at least one hyperlink anchor in the central linking document using the retrieved metadata of the selected data corresponding to the annotated hyperlink anchor.

13. The computer program product of claim 12, wherein:
the annotation comprises information from at least one field from a database containing the selected data.

14. The computer program product of claim 12, wherein:
the annotation comprises information derived from at least one field from a database containing the selected data.

15. A system for configuring a communication system, the system comprising:
at least one processor,
at least one computer readable medium in communication with the processor;
at least one program module,
stored on the at least one medium, and operative upon execution by the processor for:
in a central linking document stored in a computer data container, accepting input identifying at least one selected data;
retrieving metadata regarding at least one identified selected data;
creating at least one hyperlink anchor in the central linking document to at least one identified selected data using its corresponding retrieved metadata; and
copying at least one hyperlinked selected data to the path of the computer data container storing the central linking document.

16. The system of claim 15, wherein copying at least one hyperlinked selected data to the path of the computer data container storing the central linking document comprises:
copying the at least one hyperlinked selected data to a subdirectory of the path.

17. The system of claim 15, further comprising:
labeling at least one hyperlink anchor in the central linking document using the retrieved metadata of the selected data corresponding to the annotated hyperlink anchor.

18. The system of claim 15, further comprising:
annotating at least one hyperlink anchor in the central linking document using the retrieved metadata of the selected data corresponding to the annotated hyperlink anchor.

19. The system of claim 18, wherein:
the annotation comprises information from at least one field from a database containing the selected data.

20. The system of claim 18, wherein:
the annotation comprises information derived from at least one field from a database containing the selected data.
